(19) United States
(12) Patent Application Publication
(10) Pub. No.: US 2021/0042797 A1
(43) Pub. Date: Feb. 11, 2021

(54) Autonomous Article Grading

(71) Applicant: The Recon Group LLP, Miami, FL (US)

(72) Inventors: Sender Shamiss, Sunny Isles, FL (US); Donald T Haynie, Hollywood, FL (US)

(73) Assignee: The Recon Group LLP, Miami, FL (US)

(21) Appl. No.: 16/429,149

(22) Filed: Jun. 3, 2019

Related U.S. Application Data
(60) Provisional application No. 62/680,135, filed on Jun. 4, 2018.
(60) Provisional application No. 62/680,540, filed on Jun. 4, 2018.

(51) Int. Cl. G06Q 30/02; G06N 20/00; G06T 7/00

(52) U.S. Cl. CPC G06Q 30/0278; G06N 20/00; G06Q 30/0185; G06Q 30/0206; G06T 7/0002

(57) ABSTRACT

The present disclosure concerns a system and a method for enabling improvements in grading the condition of uniquely-identified used articles. A system for grading used articles comprises a used-article grading area, an imaging system, at least one processor and a computer-readable memory. The memory is configured to implement a machine-learning algorithm. A method of operating a system for grading the condition of a used article comprises receiving the used article into a used-article grading area, depositing the used article on an imaging surface, moving components of an imaging system relative to the position of the used article, capturing images of the used article on the imaging surface, sending the captured images to a processor, implementing a trained machine-learning algorithm for condition classification, sending the grade determined by the machine-learning algorithm to a processor, and assigning the grade received from the machine-learning algorithm to the UID assigned to the used article.

### CROSS-REFERENCE TO RELATED APPLICATION

The present application claims the benefit of U.S. Provisional Patent Application Ser. Nos. 62/680,135 and 62/680,538, filed on 4 Jun. 2018, the contents of which are herein incorporated by reference in their entirety.

### FIELD OF THE INVENTION

The present disclosure relates to reverse logistics, and more particularly to the autonomous grading of used articles.

### BACKGROUND OF THE INVENTION

‘Reverse logistics’ means “the movement of goods from an original to a new final destination.” Often, the original final destination will be a first “end user,” a “consumer,” and the new final destination will be a second consumer, or perhaps a liquidator, refurbisher or parts harvester. In any case, the usual purpose of a reverse logistics process will be to capture some of the residual value of a good or ensure its proper disposal. Reverse logistics thus encompasses the thoughtful repurposing of products and reuse of manufacturing materials, both major concerns of “circular economics.”

Census Bureau data show that US retail sales currently amount to over $5 trillion per annum. E-commerce accounts for about 10% of the total. The economic significance of the reverse logistics of general consumer merchandise—which comprises iPhones, laptop computers, flat-screen televisions and other electronic devices—can be illustrated as follows. Returned general consumer merchandise has a current retail value of about $360 billion per year in the USA alone, according to 2017 data from credible sources (US government and industry experts) and accounting for all relevant disposition channels (destroy, return to vendor, liquidate/salvage, return to shelf, etc.). The E-commerce share of all retail sales has increased rapidly for over a decade; the trend is expected to continue. The current rate of return of general consumer merchandise in the USA is around 10% for brick-and-mortar store purchases and 3-fold higher for online purchases. A sharp reversal of consumer expectation regarding return policy must be considered improbable; the expectation is spreading from the USA to other major markets in the global economy. The fraction of the global population with internet access surpassed the 50% mark in early 2019 and is projected to keep rising.

A typical reverse logistics process for an article of consumer merchandise involves several steps. Generally executed in sequential order, the steps can comprise receiving an article in a return process, identifying the corresponding product based on the universal product code (UPC) of a returned article, assigning a unique identification code (UID) to an identified article, grading the condition of a uniquely-identified article, evaluating the salability of a graded article, and selecting a disposition pathway for an evaluated article (see FIG. 1). A common disposition pathway is a listing in a secondary E-commerce marketplace.

Grading, evaluating and disposing are themselves processes comprising several sequential steps each. Improving the realized recovery value of listed articles can involve adjusting prices by a process comprising several steps. Some such steps could involve a machine configured to operate autonomously. A machine in reverse logistics, to be useful, will enable either general facilitation of a multi-step process or specific execution of a step of a process.

The development of innovative devices, systems of devices, and methods of operating devices for grading, evaluating, disposing and pricing articles of returned consumer merchandise could lead to a variety of qualitative or quantitative improvements in present practices in reverse logistics. Possible improvements include a higher rate of article throughput, a more thorough approach to article handling when warranted, and a more cost-effective approach to article handling, leading to a shorter inventory dwell time and a higher recovery of value. Efficiency and scalability of technological improvements are growing concerns in the age of E-commerce.

Efforts to advance the burgeoning field of reverse logistics have been hampered by myopic forecasts, clunky technologies and systemic inefficiencies. Secondary markets for consumer merchandise had marginal economic significance—until recently. Consequently, few practitioners have been prepared to make effective use of the latest technologies, let alone develop their own. This posed a barrier to attracting talent and made it all the harder to attract talent. Many current reverse logistics practitioners are therefore mired in practices of a bygone era. On top of this, the field is struggling to cope with a massive uptick in returned goods. Key reverse logistics processes have become sclerotic, signaling systemic inefficiencies.

Further details are worth noting. Product evaluation, or initial pricing, is troublesome, too (FIG. 1, Step 3). Market value can be hard to gauge. Historical price data can be useful, but compilers are few and quality is patchy. Tens of millions of different consumer products are sold in the US every year; the accuracy and timeliness of data and data management have become serious concerns of reverse logistics. Choice of disposition pathway can be difficult (FIG. 1, Step 4). Some possible paths have multiple hidden costs, and estimating them accurately can be non-trivial. For example, preparing a unit of consumer electronics for sale in a secondary marketplace can involve not only grading but also cleaning and accessorizing. In general, accessorizing and cleaning cannot be automated, raising all the usual labor concerns. Some disposition costs can fluctuate in ways that are not obvious. Price adjustment in relation to temporal aspects of supply, demand and other market conditions can be tricky (FIG. 1, Step 6). In general, it will not be obvious how price might be adjusted to optimize value recovery. Applying a penetrating and innovative eye to each link in the reverse logistics supply chain can put its pluses and minuses in sharper focus and potentially reveal significant opportunities for technology creation and development.

The present focus is on autonomous and accurate article grading, or condition assessment. Autonomy and accuracy in grading are crucial for approaching the ideal of optimizing the value recovery of goods in secondary marketplaces, a key concern of circular economics. Product grading is difficult, subjective and inconsistent. Cosmetic defects alone can span a broad range of actual conditions and thus translate into a broad range of justifiable prices and a high potential for failure to realize maximum recovery values.

Grade categories, or classifications, are known for different secondary markets. For example, a classification scheme for compact discs utilizes grades “mint,” “near-mint,” “very good plus,” “very good,” “good plus,” “good,” “fair” and “poor.” The National Auto Auction Association Vehicle Condition Grading Scale comprises grades “5 —excellent,” “4—better than average,” “3—normal wear and tear,” “2—signs of excessive wear and tear,” “1—signs of severe abuse,” and “0—inoperative” for paint and body (cosmetic), interior, frame/unibody, mechanical and tires. The condition categories for goods sold in a certain online marketplace are “new” (unused, unopened, original packaging, intact protective wrapping, warranty still applies), “certified refurbished” (inspected and graded by a qualified manufacturer or specialized refurbisher to like-new working condition, no visible cosmetic imperfections; 90-day limited warranty; generic box, possibly non-standard accessories; “pre-owned” or “open-box”), “used—like new,” “used—very good,” “used—good,” and “used—acceptable.” See FIG. 2, where panel A shows examples of Grade A (top) and Grade B (bottom); panel B, Grade B (top) and Grade C (bottom); and panel C, Grade C (top) and Grade D (bottom).

Grading an article will reduce its value recovery potential, whether the grader is a human or a machine. A human assessor must be trained, tested, proved and paid to assess condition. A machine must be created, developed, trained, tested, proved and powered to do its job. In either case the training process will take personnel, planning and time, and running costs will be significant. Training could also involve specialized equipment, increasing capital outlay and maintenance costs. The complexity of the grading process suggests, however, that ways of improving its efficiency and effectiveness could be identified by careful examination and addressed by technology development.

Indeed, there is every reason to believe the accurate grading of a used article of consumer merchandise will increase recovered value more than reduce it, at least on average. A reliable and cost-effective means of autonomous and accurate grading is needed. Grading accuracy is important for cultivating favorable customer relations and selling products. Customers care about the quality of goods, customer service, and the reliability of claims. Quality will often be gauged not in absolute terms but as a difference between expectation and outcome. A merchandiser will want to avoid selling poor-quality items at too high a grade (risking reputation) and high-quality items at too low a grade (losing value). A merchandiser known for unreliable claims will fail to attract or retain dollar-conscious consumers who have options, and an inability to capture value will translate into a lack of economic viability. Grading can rescue and enable the reuse of items otherwise headed straight for a landfill, recovering value. Grading can eliminate “touching” items that do not merit processing for business-to-consumer sale, lowering costs. In short, accurate article grading can influence the profitability and livelihood of a merchandiser. The following reasoning chain provides a useful summary of the relevance of grading to secondary-market sellers: Grade and perceived value are directly related, value influences price, which influences recovery, which influences revenue, which influences profitability, which influences economic success.

Many factors can influence the accuracy of article grading, or classifying according to condition. They include lighting quality, article orientation in space, human limitations and machine limitations. Light intensity, color and position can have a marked impact on human perception and the quality of photographic images. Article orientation and background are no less significant for image quality, influencing contrast, glare and perception. Other relevant human factors include quality of training, ability to concentrate, subjectivity of viewpoint, consistency of behavior, ability to learn, and ability to work independently.

Trained artificial neural network/machine-learning (ANN/ML) systems are widely used for diverse purposes. These include autonomous system function, conversation and human interaction, goal-driven system function, hyper-personalization, pattern and anomaly detection, predictive analytics and decision making, and object recognition. Different approaches to image-based machine learning and training are known.

If a machine learning system is used for article grading, various machine factors will influence grading accuracy. They include quality of the ANN/ML algorithm, quality of the training dataset (number of different images, quality of images, and degree to which the images represent the space of all possible images), extent of ANN/ML system training (number of images used in ANN/ML system training, number of times the ANN/ML system has “seen” each image), related inaccuracies, likelihood of systematic error, and so on. The many factors influencing the accuracy of article grading suggest possible opportunities for advancing technology to achieve desirable outcomes in article processing.

Envisioned advantages of an ANN/ML system for article grading include but are not limited to improved autonomy of the process, reduced subjectivity and therefore increased accuracy in grading, increased thoroughness in defect detection (identification of all true positives), decreased false identification of defects (elimination of all false positives), improved decision making based on data, increased time- and cost-effectiveness to achieve a specified performance criterion for automated grading, and the ability to self-correct and thus improve in grading accuracy. These advantages can lead to improvements in determining costs throughout the supply chain, basing decisions on real-time or near real-time data, forecasting key metrics in supply chain logistics, selecting disposition channels, timing market entry, and recovering residual value of goods. An ANN/ML system, though necessarily imperfect, can be advantageous for redirecting human labor to higher-value activities, reducing or eliminating subjective aspects of grading, and reducing article processing time. In short, the advantages of ANN/ML over a human assessor can outweigh the disadvantages in article grading.

For such reasons and others, it is desirable to develop improved systems and methods for automating and optimizing aspects of secondary goods processing. Despite advances in this area, further improvements are possible.

### SUMMARY OF THE INVENTION

In view of the foregoing, it is an object of the present disclosure to advance accurate autonomous grading of used articles. In one aspect, the present invention comprises a system for grading the condition of a used article identified by a UID. The system comprises a used-article grading area, an imaging system, at least one processor and a computer-readable memory. The used-article grading area is configured to receive the used article. The imaging system is configured to capture one or more images of the used article in the used-article grading area. The at least one processor is configured to be in electrical communication with the imaging system, to receive from the imaging system one or more images of the used article, and to assign a grade to the UID of the used article. The computer-readable memory is configured to be capable of carrying out non-transitory computer-executable instructions to cause the at least one processor to facilitate grading the used article, the computer-executable instructions comprising instructions that, when executed by the at least one processor, implements a machine-learning algorithm.

In another aspect, the present invention comprises a method of operating a system for grading the condition of a used article. The method comprises receiving the used article into a used-article grading area, depositing the used article on an imaging surface on which it can lie at rest, moving one or more components of an imaging system relative to the position of the used article on the imaging surface, capturing one or more images of the used article while it lies at rest on the imaging surface, sending the captured images of the used article to one or more processors, implementing a trained machine-learning algorithm to grade the used article by determining the closest match to a condition classification, sending the grade determined by the machine-learning algorithm to one or more processors, and assigning the grade received from the machine-learning algorithm to the UID assigned to the used article.

The present system and method involve a trained artificial neural network, concern real products, and are used to produce concrete and tangible results, definite outcomes.

These and other objects, aspects and advantages of the present invention will be better appreciated in view of the drawings and following detailed description of preferred embodiments.

### BRIEF DESCRIPTION OF THE DRAWINGS

For a fuller understanding of the invention, reference is made to the following detailed description, taken in connection with the accompanying drawings illustrating various embodiments of the present invention, in which:

FIG. 1 shows a reverse logistics process for an article of consumer merchandise, highlighting grading (Step 2);

FIGS. 2A-C show examples of different grades of iPhones;

FIG. 3 shows a schematic view of a used article grading process that involves a machine-learning system;

FIG. 4 shows a schematic view of a system of the present invention; and

FIG. 5 shows a flowchart of a method of the present invention.

### DETAILED DESCRIPTION OF PREFERRED EMBODIMENTS

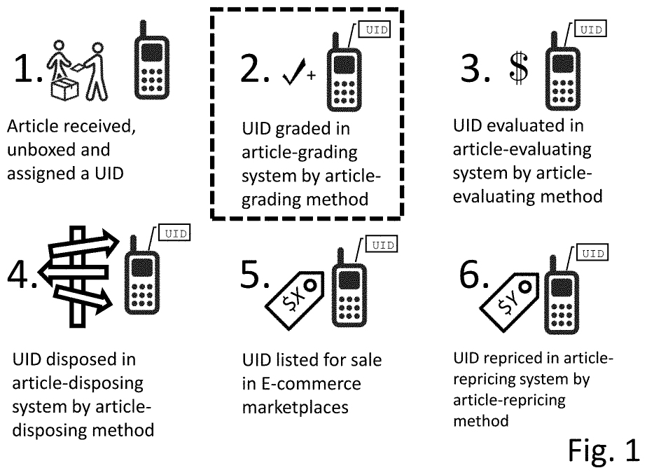

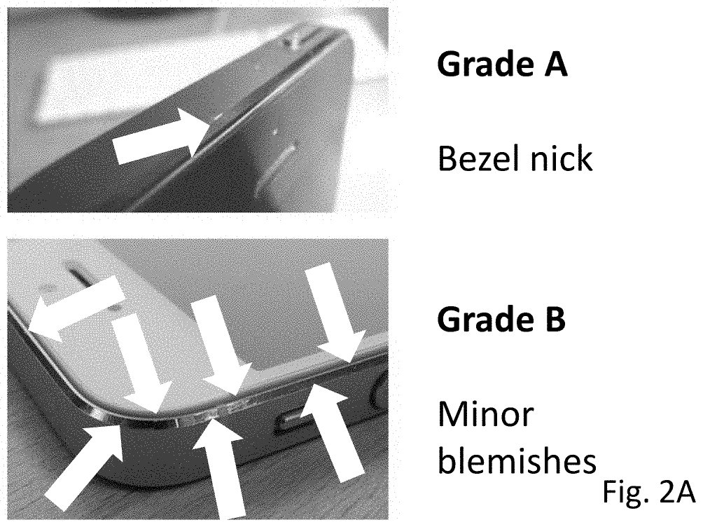

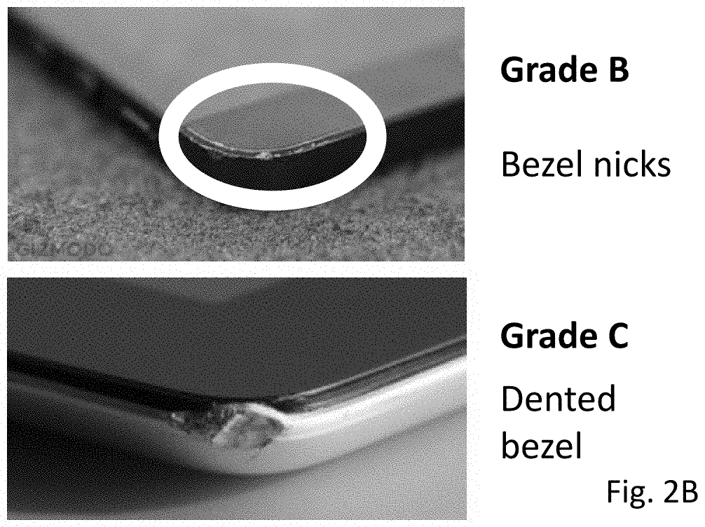

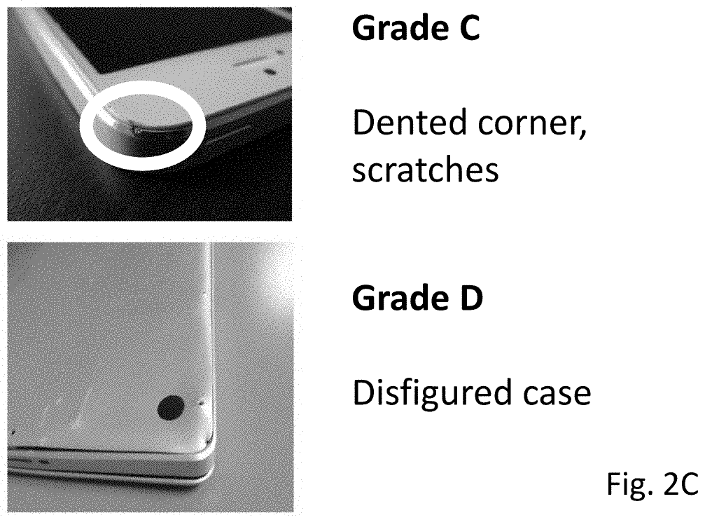

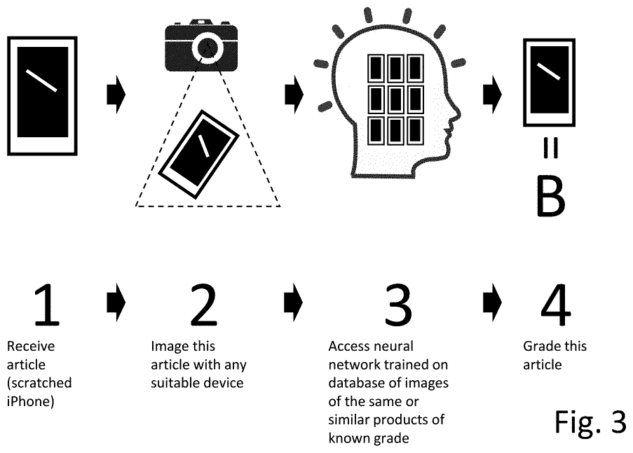

FIG. 1, it will be recalled, shows a reverse logistics process for an article of consumer merchandise. A dashed line highlights the focus of the present invention: used article grading (Step 2). FIGS. 2A-C display examples of different grades of iPhone. FIG. 3 shows a schematic view of an article grading process that involves a machine-learning system. There are four steps in the process. In the first, a used article (a scratched iPhone) is received. Second, the article is imaged with a suitable device, for instance, a camera. Third, a trained neural network is accessed. The training process involves a dataset of images of the same or similar products of known grade. Fourth, the article is assigned a grade, in this case, B′.

The present invention will now be described more fully hereinafter with reference to further accompanying drawings. Preferred embodiments of the invention are described. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

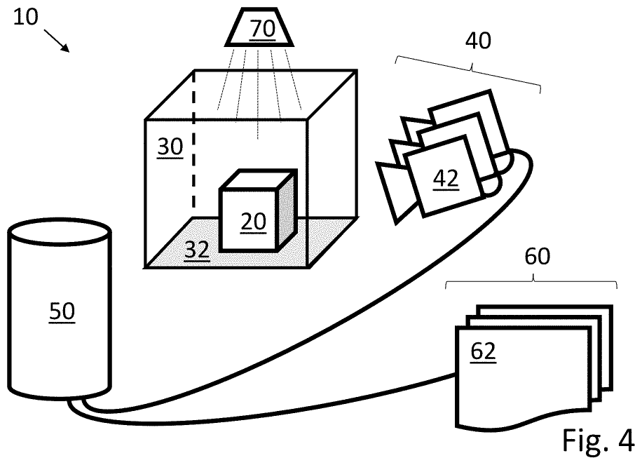

The present system 10 for grading the condition of a used article 20 identified by a UID 22 comprises a used-article grading area 30, an imaging system 40, at least one processor 50 and a computer-readable memory 60 (FIG. 4). The used-article grading area 30 is configured to receive the used article 20. The imaging system 40 is configured to capture one or more images of the used article 20 in the used-article grading area 30. The at least one processor 50 is configured to be in electrical communication with the imaging system 40, to receive from the imaging system 40 one or more images of the used article 20, and to assign a grade 24 to the UID 22 of the used article 20. The computer-readable memory 60 is configured to be capable of carrying out non-transitory computer-executable instructions to cause the at least one processor 50 to facilitate grading the used article 20, the computer-executable instructions comprising instructions that, when executed by the at least one processor 50, implements a machine-learning algorithm 62.

In one embodiment, the used-article grading area 30 is further configured to be approximately cubical in shape and no greater than 1 cubic meter in volume. In another embodiment, the used-article grading area 30 is further configured to accommodate the physical presence of at least one used article 20 at a time. In another embodiment, the used-article grading area 30 is further configured to comprise an imaging surface 32 on which the used article 20 can be at rest for a pre-determined time period.

In another embodiment, the imaging system 40 is further configured to comprise one or more imaging devices 42. The one or more imaging devices 42 can capture images of the used article 20 from above the imaging surface 32. The one or more imaging devices 42 can move in coordination to enable imaging of the used article 20 from different angles. The one or more imaging devices 42 can send images of the used article 20 in an electronic format to the at least one processor 50.

In another embodiment, the system 10 further comprises at least one photon source 70 configured to illuminate the used-article grading area 30.

In another embodiment, the machine-learning algorithm 62 is configured to grade the used article 20 as being more like one than the other pre-determined grade categories, based on the training of the machine-learning algorithm 62 and the one or more images of the used article 20 captured by the imaging system 40, and to send condition data thus determined to the at least one processor 50. The processor 50 can assign to the UID 22 the grade 24 received from the machine-learning algorithm 62. The used article 20 can be a consumer electronic device.

One embodiment of the present invention can be described as follows. The autonomous article grading system comprises a Canon application programming interface (API)-compatible camera, a version of the Canon Camera Control API, an ANN/ML system pre-trained for article grading, a generic computer with suitable memory storage and retrieval properties, and appropriate means of device interconnection for electronic communications. The camera is or is not attached to an articulating camera arm under robotic control, enabling autonomous image capture of an article from its nominal front, back and sides; the article remaining in one position on an imaging surface for all image capture. The ANN/ML system of the same embodiment is described as follows.

The ANN/ML system runs on the generic computer. The ANN/ML system detects and categorizes any defects present in captured images of articles (e.g. scratches, chips, dings/dents, cracks, discoloration, part separation) and, based this analysis, categorizes article grade as ‘A’ (few defects, if any), ‘B’ (a “like new” intermediate grade), ‘C’ (a not “like new” intermediate grade) or ‘D’ (many defects or severe damage). Classification accuracy at an acceptable error rate requires the ANN/ML system to have been trained on a dataset comprising many labeled images of independently-graded articles. The prediction accuracy of the ANN/ML system can improve as the number of images of articles fed to the system increases, as each analysis step results in an adjustment of the weighting factors in the artificial neural network. The generic computer can store in memory different sets of weighting factors for the ANN/ML system, each corresponding to a specific product or closely-related group of products. Advantages of use of this ANN/ML system include grading articles autonomously, reducing human inconsistency in a crucial aspect of the reverse logistics of some products, and enabling warehouse clerks to focus attention on aspects of reverse logistics that cannot be automated or are too difficult to automate at this time.

A training dataset for the present grade classifier system will consist of many images of each product of interest, each image being labeled with a grade. “Synthetic” images can be generated to ensure enough data for the trained ANN/ML system to classify instances at an acceptable error rate, bootstrapping the training process. For example, a machine learning tool can be used to add blemishes of random size, shape, color and intensity at random locations on images of pristine products, and the resulting images, some labeled, some unlabeled for grade, can be used in a semi-supervised training process to train the machine learning system for grading. Product image processing can involve autonomous segmentation, filtering, histogram analysis, thresholding and other standard techniques. Identifying device anomalies or defects in images can involve amplitude or frequency modulation. Grade classification can involve partial least-squares regression. Alternative classifiers include k-nearest neighbor, support vector machine, naïve Bayes and linear algorithms. Performance can be assessed as accuracy, sensitivity and specificity, as in receiver-operator characteristic analysis.

The autonomous grading process of the present invention comprises several sequential steps. It is assumed that the identity of an article to be graded is known by any convenient means, for example, use of a scanner to read a UPC displayed on an article or a processor of an image of a UPC on the article. In a first step of the grading process, one or more images of the article are captured for assessment of condition. In one embodiment, one or more digital cameras are used for the purpose. Second, the one or more images are fed to a pre-trained ANN/ML system in a data transfer step. Training of the ANN/ML will generally have involved analysis of many images of the same or related products. Third, cosmetic anomalies or defects of the article are identified by the ANN/ML system. For example, images of the article can be segmented to facilitate comparisons with images of related articles. And fourth, the ANN/ML system assigns a grade to the article at a quantifiable error rate. Use of a properly trained ANN/ML system will enable not only accurate classification but also improvements in accuracy as the number of instances, or articles classified, grows. Classifying and machine learning are the two main functions of a “learning-classifier system.” The present invention couples a computer (or machine) vision system and a machine learning classifier system for automated grading of articles of consumer merchandise for possible sale in a secondary marketplace.

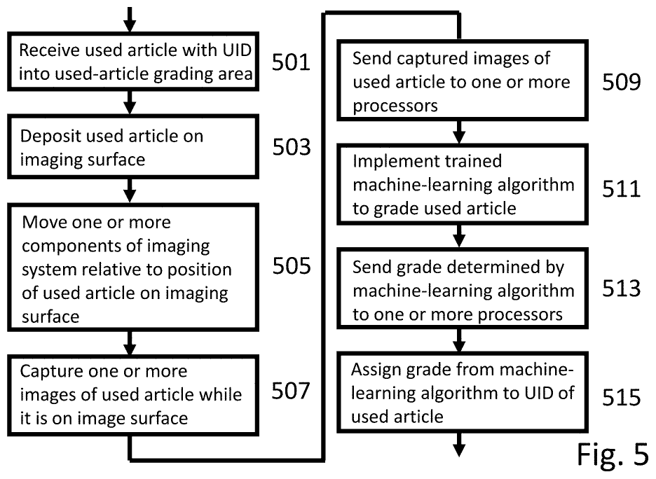

FIG. 5 shows a flowchart of the present method of operating a system 10 for grading the condition of a used article 20. The method comprises receiving the used article 20 into a used-article grading area 30 in step 501, depositing the used article 20 on an imaging surface 32 on which it can lie at rest in step 503, moving one or more components of an imaging system 40 relative to the position of the used article 20 on the imaging surface 32 in step 505, capturing with the imaging system 40 one or more images of the used article 20 while it lies at rest on the imaging surface 32 in step 507, sending the captured images of the used article 20 from the imaging system 40 to one or more processors 50 in step 509, implementing a trained machine-learning algorithm 62 to use the images received from the imaging system 40 to grade the used article 20 by determining a closest match to a condition classification in step 511, sending the grade 24 determined by the machine-learning algorithm 62 to one or more processors 50 in step 513, and assigning the grade 24 received from the machine-learning algorithm 62 to the UID 22 assigned to the used article 20 in step 515.

In one embodiment, capturing images of the used article 20 further includes using the imaging system 40 to capture images of the used article 20 from two or more different angles. The method can comprise moving the imaging system 40 to change an angle to another angle of the two or more different angles at which the imaging system 40 captures images of the used article 20.

In another embodiment, capturing images of the used article 20 further includes capturing images of the used article 20 with an imaging system 40 operably associated with the used-article grading area 30.

In another embodiment, the method comprises illuminating the used-article grading area 30 while capturing images of the used article 20 with the imaging system 40.

In another embodiment, the used article 20 is an electronic device.

The foregoing explains how the present invention uniquely applies machine learning to the automation of article grading. The same general approach can be applied to numerous different products, not only used consumer electronic devices. The approach can potentially lead to the creation of industry standards or regulations in article grading.

The following definitions are used herein:

‘Article’ means “a member of a class of things” and, more specifically, “a thing, often an item of merchandise, the exterior surface of which can display an optical, machine-readable representation of data, for example, a UPC.” ‘Article’ represents a certain replica of a product. An article could be an electronic device with a unique serial number and will have a certain grade. A product can be identified by a UPC and cannot have a certain grade. A synonym for ‘article’ in this context is ‘item’.

‘Artificial intelligence’ means “the so-called intelligent behavior displayed by some machines, for example, devices that can detect features of their surroundings, for example a field of view, respond, and thus increase the likelihood of success in achieving a goal with little or no human input.” Aspects of current interest in AI research include “machine reasoning,” data acquisition, data processing, data interpretation, “machine planning,” “machine learning,” natural language processing, “machine perception” and the ability of machines to move and manipulate objects, often autonomously.

‘Data science’ means “an interdisciplinary field that makes use of various scientific methods, theories and computer algorithms to extract knowledge and gain insights from data, whether structured or unstructured prior to analysis.”

‘Data mining’ means “using a computational approach to identify correlations of possible utility or value.” For example, data mining could reveal price/availability relationships between items, and this information could be used to predict price/availability changes in one item based on price/availability changes in a related item or estimate value of one item based on value of a related item.

‘Defect’ means “an imperfection in an article relative to what is typically considered ‘new’, for example, a scratch or dent.”

‘Disposition’ means “a supply-chain channel in reverse logistics, for example, return-to-shelf, return-to-vendor, parts harvester and landfill.”

‘Dynamic self-learning’ means “a continual process of machine learning, wherein weighting factors between artificial neurons in an artificial neural network are continually adjusted in response to new data.” In the case of a classifier system, for example, the continual adjustment of weighting factors can increase the likelihood of correct autonomous classification.

‘Factor’ means “a circumstance, fact, trend or the like” that can influence a decision, for example, the influence of inventory on hand on the choice of initial sale price of an article.

‘Grade’ means “the condition of an article based on some number of cosmetic defect definitions.” A product with a high gloss surface, for example, is easily scuffed or scratched. Grade is generally considered a key determinant of the initial price of an article offered for resale. Often, a human expert will assign a grade to an article based on a direct assessment of physical condition, not technical functionality or performance. In the case of retail merchandise, for example, grade ‘A’ might signify an article in “excellent physical condition;” ‘B’, “good physical condition;” ‘C’, “fair physical condition;” and ‘D’, “poor physical condition.” The severity (typically, size and depth), number and location of cosmetic defects will influence grade. In the case of iPhones, for instance, an inspector will examine individual articles for blemishes, chips/nicks/gouges, cracks, “dead” pixels, dings/dents, pressure spots, scratches/scrapes, scuffs/abrasions, and screen burn/ghost images. Grading is subjective, but a high level of concurrence and article-to-article consistency can be achieved by well-trained human inspectors.

‘Grading’ means “assigning a grade to an article, whether it is done by a human or a machine.”

‘Imaging device’ means “a machine designed for capturing images, often based on photon reception in the visible range; for example, a camera.”

‘Intelligent decision engine’ means “a decision engine can optimize the execution performance of a ruleset.” A typical decision engine works in one of two ways. In one, the decision engine queries the user to specify criteria for detection or analysis in any given instance. The decision engine then provides a list of possibilities that match the user's criteria and possibly ranks the list. The user then selects from among these options. In the other, the decision engine collects data over time to establish a user's typical preferences.

‘Launch date’ means “the date a product first becomes available in a marketplace.”

‘Machine learning’ means “the training and/or use of an artificial neural network to accomplish a specified task,” for example, promote the success of autonomous business intelligence gathering on known factors or implement new factors to improve automated methods.

‘Machine vision’ means “all technologies and methods used to extract information from an image.” The information extracted can be simple, for example, a good-part/bad-part signal, or complex, for example, the identity, position and orientation of each object in an image. A machine vision process will generally involve acquiring an image, transferring the image data, employing digital image processing methods, extracting the desired information, and in some cases basing decisions on the extracted information. The process will generally utilize appropriate illumination, usually with photons, one or more imaging devices (e.g. cameras), one or more image processors, related software, and one or more output devices. The sequence of image processing will generally comprise applying filters, extracting articles, extracting data from the articles and communicating data. Automate article identification and utilize images for autonomous grading.

‘Natural language processing’ means “the programming of computers to process and analyze large amounts of natural language data, including speech recognition and natural language understanding.” A natural language processing system can automate analysis of textual data sources, e.g. user comments, making them a major source of information for pricing.

‘Neural network’, or ‘artificial neural network’ means “a computer system modeled on the human brain and nervous system. Automate grading and improvement of automated grading.”

‘Pricing’ means “the process whereby the price of a product is set.”

‘Product life cycle’ generally means “the stages a product goes through from when it is first conceived until it is removed from the market, though more generally the definition can include the entry of a product into the secondary market and other possibilities up until being destroyed.”

‘Proprietary/internal factors’ means “pricing rules, discounting rules, seasonal adjustments and the like; and it can include decisions related to warehouse availability, product aging, supplier-related delays in shipments and the like.”

‘Purchase history’ means “a record and possibly a means of tracking and managing all items purchased.”

‘R1’ means “a proprietary software program for inventory management and related functions in supply chain reverse logistics.”

‘Recovery’ is a comparison of the actual sale price of an article and a typical retail price of the article, for example, manufacturer's suggested retail price (MSRP).

‘Sales velocity’ means “a sales metric influenced by four factors: v=ndw/Δt.” Here, v is sales velocity, n is number of sales opportunities, d is the average deal value, w is the average success rate, and Δt is the time interval.

‘Secondary market’ means “a post-retail supply chain channel that provides an outlet for unwanted goods from the primary market so that they can be bought and sold.”

‘Self-parsing machine learning’ means “the autonomous analysis of a string of symbols according to rules. In computer science, the term is used in the analysis of computer languages, where it refers to the syntactic analysis of the input code into its component parts or describes a splitting or separation.”

‘Smart’ means “containing a built-in processor.”

‘Unique identification code’ means a unique means of identifying a used article. In the present context, a UID is assigned to an article of a certain UPC, itself a unique identifier. Each UPC has a corresponding template, which is used to store product-related information, including a brief product description, MSRP, size (nominal length, width and height), and weight. The size and weight data are useful for determining shipping cost. MSRP can be a useful for setting the margin needed to make disposition decisions. Use of a UID as a data record label is useful for linking a variety of processes related to reverse logistics.

The foregoing is provided for illustrative and exemplary purposes; the present invention is not necessarily limited thereto. Rather, those skilled in the art will appreciate that various modifications, as well as adaptations to particular circumstances, are possible within the scope of the invention as herein shown and described.

What is claimed is:

1. A system for grading the condition of a used article identified by a UID, the system comprising:
a used-article grading area configured for receiving the used article;
an imaging system configured for capturing one or more images of the used article in the used-article grading area;
at least one processor configured for being in electrical communication with the imaging system, receiving from the imaging system one or more images of the used article, and assigning a grade to the UID of the used article; and
a computer-readable memory configured for carrying out non-transitory computer-executable instructions to cause the at least one processor to facilitate grading the used article, the computer-executable instructions comprising instructions that, when executed by the at least one processor, implements a machine-learning algorithm.

2. The system of claim 1, wherein the used-article grading area is further configured for being approximately cubical in shape and no greater than 1 cubic meter in volume.

3. The system of claim 1, wherein the used-article grading area is further configured for accommodating the physical presence of at least one used article at a time.

4. The system of claim 1, wherein the used-article grading area is further configured for comprising an imaging surface on which the used article can be at rest for a pre-determined time period.

5. The system of claim 1, wherein the imaging system is further configured for comprising one or more imaging devices.

6. The system of claim 5, wherein the one or more imaging devices are configured for capturing images of the used article from above the imaging surface.

7. The system of claim 5, wherein the one or more imaging devices are configured for moving in coordination to enable imaging of the used article from different angles.

8. The system of claim 5, wherein the one or more imaging devices are configured for sending images of the used article in an electronic format to the at least one processor.

9. The system of claim 1, the system further comprising at least one photon source configured for illuminating the used-article grading area.

10. The system of claim 1, wherein the machine-learning algorithm is configured for grading the used article as more like one than the other pre-determined grade categories, based on the training of the machine-learning algorithm and on the one or more images of the used article captured by the imaging system, and sending grade data thus determined to the at least one processor.

11. The system of claim 10, wherein the processor is further configured for assigning to the UID of the used article the grade data received from the machine-learning algorithm.

12. The system of claim 1, wherein the used article is a consumer electronic device.

13. A method of operating a system for grading the condition of a used article, the method comprising:
receiving the used article into a used-article grading area;
depositing the used article on an imaging surface on which it can lie at rest;
moving one or more components of an imaging system relative to the position of the used article on the imaging surface;
capturing one or more images of the used article while it lies at rest on the imaging surface;
sending the one or more captured images of the used article to one or more processors;
implementing a trained machine-learning algorithm to use the captured images to grade the used article by determining the closest match to a condition classification;
sending the grade determined by the machine-learning algorithm to the one or more processors; and
assigning the grade received from the machine-learning algorithm to the UID assigned to the used article.

14. The method of claim 13, wherein capturing images of the used article further includes capturing images of the used article from two or more different angles.

15. The method of claim 14, the method further comprising moving the imaging system to change an angle to another angle of the two or more different angles at which the imaging system captures images of the used article.

16. The method of claim 13, wherein capturing images of the used article further includes capturing images of the used article with an imaging system operably associated with the used-article grading area.

17. The method of claim 13, the method further comprising illuminating the used-article grading area while capturing images of the used article with the imaging system.

18. The method of claim 13, wherein the used article is an electronic device.
